(19) United States
(12) Patent Application Publication
(10) Pub. No.: US 2026/0221538 A1
(43) Pub. Date: Jul. 30, 2026

(54) RECHARGEABLE BATTERY PACKS AND METHODS OF MANUFACTURING SUCH BATTERY PACKS

(71) Applicant: HUSQVARNA AB, Huskvarna (SE)

(72) Inventors: Filip STENOW, Huskvarna (SE); Benjamin LANNSJO, Husvkarna (SE); Philip DOLK, Huskvarna (SE); Damir MEMIC, Huskvarna (SE); Par MARTINSSON, Huskvarna (SE); Henric SVENSSON, Huskvarna (SE)

(21) Appl. No.: 19/148,527

(22) PCT Filed: Nov. 16, 2023
(86) PCT No.: PCT/SE2023/051160

§ 371 Date: Jul. 16, 2025

(30) Foreign Application Priority Data
Jan. 16, 2023 (SE) 2350031-7

(51) Int. Cl. H01M 10/6563; H01M 10/613; H01M 10/6235; H01M 10/643; H01M 50/213; H01M 50/247; H01M 50/278; H01M 50/284; H01M 50/291; H01M 50/519; H01M 50/588; H01M 50/59

(52) U.S. Cl. CPC H01M 10/6563; H01M 10/613; H01M 10/6235; H01M 10/643; H01M 50/213; H01M 50/247; H01M 50/278; H01M 50/284; H01M 50/291; H01M 50/519; H01M 50/588; H01M 50/59; H01M 2220/30

(57) ABSTRACT

A rechargeable battery pack comprises first and second battery cell holders (62a, 62b), each having a set of cell holder terminals connected to the battery cell terminals, and a set of circuit board terminals (64a, 64b) arranged along a circuit board connector terminal edge (66a, 66b) of the respective battery cell holders (62a, 62b). The circuit board terminals (64a), terminal connection areas of the circuit board (46), and the circuit board connector terminal edges (66a, 66b) of the battery cell holders (62a, 62b) are embedded in said coherent body (80) of potting resin. A gasket compression ridge (78d) of a potting shell (78) compresses a potting gasket (52) to keep user interface elements (48) and a wireless transceiver module free from potting.

### FIELD OF THE INVENTION

The present invention relates to rechargeable battery packs and methods of manufacturing such battery packs.

### BACKGROUND

Handheld power tools, such as chainsaws, have been known for the last 100 years or so. Due to considerations of cost and weight vs power and operation time, most chainsaws are still powered by internal combustion engines of two-stroke type, but battery powered chainsaws are becoming increasingly popular. However, the transition to battery operation poses other difficulties; for example, the batteries should be able to sustain rough handling, and they should operate in cold and wet climate.

### SUMMARY

It is an object of the present invention to solve, or at least mitigate, parts or all of the above-mentioned problems. To this end, according to a first aspect, there is provided a rechargeable battery pack configured to be removably attached to a handheld, battery-operated, power tool, the rechargeable battery pack comprising a plurality of elongate, rechargeable battery cells, each battery cell extending in a longitudinal direction between a pair of opposing battery cell ends, said pair of battery cell ends comprising battery cell terminals of opposite polarity; a circuit board comprising control electronics; a first battery cell holder configured to receive a first set of battery cell ends comprising one end of each of said plurality of battery cells, the first battery cell holder comprising a first set of cell holder terminals connected to the battery cell terminals of said first set of battery cell ends, and a first set of circuit board terminals arranged along a circuit board connector terminal edge of the first battery cell holder, the first set of circuit board terminals being connected to a first terminal connection area of the circuit board; and a second battery cell holder configured to receive a second set of battery cell ends comprising the other end of each of said plurality of battery cells, the second battery cell holder comprising a respective set of cell holder terminals connected to the battery cell terminals of said second set of battery cell ends, and a second set of circuit board terminals arranged along a circuit board connector terminal edge of the second battery cell holder, the second set of circuit board terminals being connected to a second terminal connection area of the circuit board, wherein the first battery cell holder is partly embedded in a coherent body of potting resin, wherein first set of circuit board terminals, the first terminal connection area, and the circuit board connector terminal edge of the first battery cell holder are embedded in said coherent body of potting resin. In such a battery pack, even though the circuit board terminals may extend between separate structures of the battery pack, both ends of each respective circuit board terminal are potted in the same coherent body of potting resin. This reduces exposure to dirt and moisture and reduces the risk of short-circuiting the circuit board terminals. It also stabilizes the mechanical relationship between the battery cell holders and the circuit board, which reduces the risk of electrical failures due to e.g. mechanical shock. Each of the first and second battery cell holders may comprise a respective plurality of slots configured to receive the respective first and second sets of battery cell ends. Each slot may be configured to individually receive a single respective battery cell end; for example, individual slots may have a circular-cylindrical inner face mating with a circular-cylindrical outer face of the respective battery cell ends. The cell holder terminals of each battery cell holder may connect battery cells in serial or parallel configuration, or a combination thereof. The circuit board may comprise circuitry configured to control charging and discharging of the battery cells. By having the first battery cell holder only partly embedded in potting resin, a low weight of the battery pack is obtained, which is of particular benefit for handheld power tools. According to embodiments, the coherent body of potting resin is homogenous; such a body of potting resin may be obtained in a single potting step, and will also reduce defects such as irregularities or cavities, which may occur in interfaces between adjacent bodies of potting resin. The rechargeable battery cells may be of e.g. Lithium-ion type. They may be interconnected in groups so as to provide a maximum output voltage of the rechargeable battery pack of, typically, between 18V and 94V.

According to embodiments, the second terminal connection area, the second set of circuit board terminals and the circuit board connector terminal edge of the second battery cell holder may also be embedded in said coherent body of potting resin. Thereby, only one single coherent body of potting resin is needed to protect both sets of circuit board terminals, which facilitates manufacture of the battery pack. Alternatively, the battery pack may comprise two or more separate bodies of potting resin embedding different parts of the battery pack. Similar to the first battery cell holder, also the second battery cell holder may be embedded only partly in the coherent body of potting resin, which keeps weight low.

According to embodiments, at least some of said plurality of battery cells may be outside said coherent body of potting resin. Typically, resins having a low electrical conductivity also have a low thermal conductivity. By positioning at least some of said plurality of battery cells outside said coherent body of potting resin, an improved cooling of the battery cells may be obtained. Preferably, all of said plurality of battery cells are outside said coherent body of potting resin.

According to embodiments, the rechargeable battery pack may comprise air gaps between adjacent battery cells. Preferably, there are air gaps between the respective battery cells of several pairs of adjacent battery cells. Even more preferably, there are air gaps between the respective battery cells of all pairs of adjacent cells.

According to embodiments, the rechargeable battery pack may comprise an outer battery pack housing provided with a ventilation opening in fluid communication with said air gaps. Preferably, the outer battery pack housing comprises at least two ventilation opening in fluid communication with said air gaps, wherein said at least two ventilation openings are separated by at least 50 mm. Thereby, a continuous air flow through the rechargeable battery pack may be obtained.

According to embodiments, the circuit board may comprise an inner face facing said plurality of battery cells and outer face facing away from said plurality of battery cells.

According to embodiments, said inner face of the circuit board may be embedded in said coherent body of potting resin.

According to embodiments, the rechargeable battery pack may comprise an electric connector for connection to the handheld battery-operated power tool, and a set of connector leads extending between the circuit board and the electric connector, wherein the connector leads extend from the inner face of the circuit board, through the coherent body of potting resin. Such a configuration of the connector leads provides for a compact arrangement of the connector leads, as well as a thorough protection of the connector leads against moisture and dirt. The connector leads may be defined by one or several insulated cables.

According to embodiments, said outer face of the circuit board may be at least partly embedded in said coherent body of potting resin.

According to embodiments, the coherent body of potting resin may be bonded to a potting shell at least partly enclosing the coherent body of potting resin.

According to embodiments, said outer face of the circuit board may comprise a user interface area comprising a plurality of user interface elements free from said coherent body of potting resin, and a potting gasket enclosing said user interface area and abutting said coherent body of potting resin, said potting gasket being compressed by a gasket compression ridge on an inner face of the potting shell. Thereby, the user interface area is kept free from potting. The gasket compression ridge may define a closed loop enclosing the entire user interface area.

According to embodiments, the potting shell may be provided with a potting shell opening in register with the user interface area, wherein the user interface area is free from said coherent body of potting resin. Such an opening is particularly useful for user interface elements requiring mechanical access, such as switches. Alternatively, the potting shell may, for example, be made of transparent plastic, thereby rendering e.g. light-emitting diodes within the user interface area visible from outside the potting shell.

According to embodiments, the rechargeable battery pack may comprise an outer battery pack housing provided with a gasket compression ridge extending through the potting shell opening towards the circuit board, wherein said potting gasket is compressed by the gasket compression ridge of the outer battery pack housing. Thereby, the potting gasket may serve the double purpose of keeping potting resin out of the user interface area, to enable access to the user interface elements, and sealing the user interface area against dirt and moisture via the outer battery pack housing. The gasket compression ridge of the outer battery pack housing may define a closed loop enclosing the entire user interface area, within the perimeter of the gasket compression ridge of the potting shell. Alternatively or additionally, the gasket compression ridge of the outer battery pack housing may define closed loops about individual user interface elements within the user interface area. The potting gasket may be configured as an adhesive film stuck directly onto the circuit board. The plurality of user interface elements may comprise, for example, one or several light-emitting diodes and/or switches, and/or a wireless transceiver module such as a Bluetooth module, for example a Bluetooth Low Energy, BLE, module.

According to embodiments, the potting gasket may comprise a plurality of gasket apertures individually enclosing respective user interface elements, and the gasket compression ridge of the outer battery pack housing compresses the potting gasket in closed loops about the respective gasket apertures. Thereby, leakage of water or dirt between different user interface elements is minimized. Moreover, the separate slots defined by the gasket apertures and closed loops prevent stray light leakage, which improves distinguishing between different light-emitting diodes positioned in different slots.

According to embodiments, the potting gasket may be configured as a coherent foam rubber sheet. Such a gasket is inexpensive to manufacture. The foam rubber sheet may comprise a base polymer of natural and/or synthetic rubber, such as polyurethane. Preferably, the foam rubber sheet is a closed-cell rubber foam sheet.

According to embodiments, said circuit board may extend in a circuit board plane, and said coherent body of potting resin may have a total height, perpendicular to the circuit board plane, of less than 40 mm. Thereby, the weight of the rechargeable battery pack may be kept low. More preferably, said coherent body of potting resin has a total height, perpendicular to the circuit board plane, of less than 30 mm, or of less than 20 mm.

According to embodiments, the cell holder terminals of said first set of cell holder terminals may be at least partly moulded into the first battery cell holder. Such an arrangement provides for a liquid-tight interface between the cell holder terminals of the respective cell holders. Optionally, the cell holder terminals of said second set of cell holder terminals are at least partly moulded into the second battery cell holder. An exemplary suitable material for the battery cell holders is polybutylene terephthalate.

According to embodiments, said first cell holder may have an outer face facing away from the battery cells, and an inner face receiving the first set of battery cell ends, wherein said first cell holder is provided with a set of gaps in register with the battery cell terminals of said first set of battery cell ends, the gaps exposing said first set of cell holder terminals on the outer face of said first cell holder. Thereby, the cell holder terminals can be welded to the battery cell terminals of said first set of battery cell ends via the gaps. Optionally, similar to the first cell holder, said second cell holder has a respective outer face facing away from the battery cells and a respective inner face receiving the second set of battery cell ends, wherein said second cell holder is provided with a respective set of gaps exposing said second set of cell holder terminals on the outer face of said second cell holder.

According to embodiments, the rechargeable battery pack may comprise a flexible cell holder cover sheet on the outer face of the first cell holder, the cell holder cover sheet covering said set of gaps exposing said first set of cell holder terminals on the outer face of said first cell holder. Thereby, the cell holder cover sheet may protect the outer faces of the first set of cell holder terminals against dirt, moisture and water. The cell holder cover sheet may be configured as an adhesive film stuck directly onto the outer face of the of the first cell holder. The cell holder cover sheet may be a first cell holder cover sheet, and optionally, the rechargeable battery pack may further comprise a second flexible cell holder cover sheet on the outer face of the second cell holder, covering a set of gaps exposing said first set of cell holder terminals.

According to embodiments, said first cell holder cover sheet may be a foam rubber sheet. The foam rubber sheet may comprise a base polymer of natural and/or synthetic rubber, such as polyurethane. Preferably, the foam rubber sheet is a closed-cell rubber foam sheet. The foam rubber sheet may be partly compressed between the first cell holder and an outer battery pack housing of the battery to further improve liquid tightness and/or to take up mechanical tolerances between the first cell holder and the outer battery pack housing. Any second cell holder cover sheet, as the case may be, may be a foam rubber sheet configured and positioned in accordance with the first cell holder cover sheet, mutatis mutandis.

According to a second aspect, there is provided a rechargeable battery pack configured to be removably attached to a handheld battery-operated power tool, which rechargeable battery pack may optionally be configured in accordance with any of the embodiments hereinabove, the rechargeable battery pack comprising a plurality of elongate, rechargeable battery cells; a circuit board comprising control electronics, the circuit board comprising a user interface area comprising a wireless transceiver module, wherein the circuit board is partly embedded in a coherent body of potting resin, and wherein the user interface area is free from said coherent body of potting resin; and a potting gasket abutting said coherent body of potting resin and separating said user interface area from said coherent body of potting resin, wherein said wireless transceiver module is separately overmoulded with a plastic overmould body, wherein said plastic overmould body comprises a sealing ridge extending in a closed loop on a bottom face of the wireless transceiver module, the sealing ridge sealingly abutting the circuit board. The combination of a potting gasket, keeping the user interface area free from potting, with a separate overmould with an integrated sealing ridge of the wireless transceiver module, enables removal of the wireless transceiver module from the circuit board, while still enabling a high degree of resistance against dirt and water. This facilitates, for example, upgrading the wireless transceiver module to updated revisions. Preferably, the plastic overmould leaves an antenna of the wireless transceiver module exposed. According to embodiments, the plastic overmould may be formed of a plastic having a Shore D hardness exceeding 10; this may facilitate manufacture. The plastic overmould may be formed of a thermoplastic, such as polyamide. According to embodiments, the wireless transceiver module may be a Bluetooth module, for example a Bluetooth Low Energy (BLE) module.

According to embodiments, the bottom face of the wireless transceiver module may comprise a set of connection terminals connected, but unsoldered, to a mating set of connection terminals of the circuit board, wherein the wireless transceiver module is biased to the circuit board. Thereby, a high degree of tightness of the sealing ridge is warranted, in combination with ease of replacement of the wireless transceiver module. In particular, the bias may slightly compress the sealing ridge. The bias may be generated by one or more screws pressing the wireless transceiver module towards the circuit board. According to embodiments, the wireless transceiver module may be provided by a set of screw holes for mounting screws.

According to a third aspect, there is provided a rechargeable battery pack configured to be removably attached to a handheld battery-operated power tool, which rechargeable battery pack may optionally be configured in accordance with any of the embodiments hereinabove, the rechargeable battery pack comprising a plurality of rechargeable battery cells; and a circuit board comprising control electronics, wherein the circuit board comprises an inner face facing said plurality of battery cells and outer face facing away from said plurality of battery cells, wherein the outer face of the circuit board comprises a user interface area comprising a plurality of user interface elements, wherein said outer face of the circuit board is partly embedded in a coherent body of potting resin, which is bonded to a potting shell at least partly enclosing the outer face of the circuit board and the coherent body of potting resin, wherein the potting shell is provided with a potting shell opening in register with the user interface area, and the user interface area is free from said coherent body of potting resin, the rechargeable battery pack further comprising a potting gasket enclosing said user interface area and abutting said coherent body of potting resin, said potting gasket being compressed between the circuit board and a gasket compression ridge on an inner face of the potting shell, wherein the gasket compression ridge defines a closed loop extending about the potting shell opening.

According to embodiments, the rechargeable battery pack may comprise an outer battery pack housing provided with a gasket compression ridge extending through the potting shell opening towards the circuit board, wherein said potting gasket is compressed by the gasket compression ridge of the outer battery pack housing.

According to a fourth aspect, there is provided a combination of a rechargeable battery pack according to any of the preceding aspects or embodiments, and a handheld battery-operated power tool comprising a battery connector adapted to connect to the rechargeable battery pack.

According to a fifth aspect, there is provided a method of manufacturing a rechargeable battery pack, comprising: providing a plurality of battery cells, a circuit board, a first battery cell holder comprising a respective set of circuit board terminals arranged along a circuit board connector terminal edge of the first battery cell holder, and a second battery cell holder comprising a respective set of circuit board terminals arranged along a circuit board connector terminal edge of the second battery cell holder; positioning a first set of battery cell ends of the plurality of battery cells in the first battery cell holder; positioning a second set of battery cell ends of the plurality of battery cells in the second battery cell holder; positioning the circuit board adjacent to the circuit board connector terminal edges of the first and second battery cell holders, such that an inner face of the circuit board faces said plurality of battery cells and outer face of the circuit board faces away from said plurality of battery cells; electrically connecting the circuit board terminals of the first and second battery cell holders to the circuit board; placing the circuit board and the circuit board connector terminal edges of the first and second battery cell holders in a potting shell shaped as a tray, with the outer face of the circuit board facing downwards and the first and second battery cell holders extending up from the potting shell; and filling potting resin in the potting shell, to form a coherent body of potting resin at least partly embedding the circuit board connector terminal edges of the first and second battery cell holders and the circuit board. Thereby, a dirt and water-resistant interface between the circuit board and the battery cell holders may be obtained in a simple and inexpensive manner. The method steps need not necessarily be performed in the above order. According to embodiments, prior to filling potting resin in the potting shell, the potting shell may be snapped to the battery cell holders, for example using cantilever hooks. The potting shell may define part of an outer housing of the rechargeable battery pack.

According to embodiments, the method may comprise: prior to filling potting resin in the potting shell, positioning a potting gasket between the circuit board and the potting shell, the potting gasket enclosing a user interface area and/or a transceiver mounting area of the circuit board; and compressing the potting gasket by pressing the circuit board against the potting shell such that, when filling the potting resin in the potting shell, the potting gasket prevents the potting resin from reaching the user interface area and/or transceiver mounting area. The potting shell may be provided with a potting shell opening in register with the user interface area and/or transceiver mounting area.

According to embodiments, the potting shell may be provided with a potting shell opening in register with the user interface area and/or transceiver mounting area, wherein the method may further comprise: providing an outer battery pack housing; compressing the potting gasket by pressing the outer battery pack housing against the potting gasket within the perimeter of the potting shell opening, such that a sealing engagement is obtained between the outer battery pack housing and the circuit board via the potting gasket; and fixing the outer battery pack housing in relation to the circuit board. The compression and fixing steps may be performed simultaneously by e.g. moving the outer battery pack housing towards the circuit boards by means of attachment screws.

According to embodiments, the method may comprise: welding a set of cell holder terminals of the first battery cell holder to battery cell terminals of the first set of battery cell ends via a set of gaps through said first cell holder; welding a set of cell holder terminals of the second battery cell holder to battery cell terminals of the second set of battery cell ends via a set of gaps through said second cell holder; applying a first flexible cell holder cover sheet on an outer face of the first cell holder to cover the set of gaps through the first cell holder; and applying a second flexible cell holder cover sheet on an outer face of the second cell holder to cover the set of gaps through the second cell holder. Again, the method steps need not necessarily be performed in the above order.

It is noted that embodiments of the invention may be embodied by all possible combinations of features recited in the claims. Further, it will be appreciated that the various embodiments described for the device according to the first aspect are combinable with the devices according to the second and third aspects and vice versa. Similarly, the various embodiments described for the devices according to the first, second, third and fourth aspects are combinable with the method according to the fifth aspect, and vice versa.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a plan view of a handheld battery-powered chainsaw as seen from the side, the chainsaw holding a rechargeable battery pack;

FIG. 2 is a perspective view of the chainsaw of FIG. 1, illustrating the connection of the battery pack to the chainsaw;

FIG. 3 is a view of the battery pack of FIGS. 1-2 in a first perspective;

FIG. 4 is a view of the battery pack of FIGS. 1-2 in a second perspective;

FIG. 5A is a perspective view of interior parts of a wireless transceiver module of the battery pack of FIGS. 1-4;

FIG. 5B is a perspective view the wireless transceiver module of the battery pack of FIGS. 1-4;

FIG. 5C is a perspective view the wireless transceiver module of FIG. 5B as seen obliquely from below;

FIG. 6 is an exploded view in perspective of a circuit board of the battery packs of FIGS. 1-4, the circuit board including the transceiver module of FIGS. 5A-5C;

FIG. 7 is an exploded view of a battery cell assembly of the battery pack of FIGS. 1-4;

FIG. 8A is a perspective view of a battery cell holder of the battery cell assembly of FIG. 7;

FIG. 8B is a perspective view of a set of cell holder terminals of the battery cell holder of FIG. 8A;

FIG. 9 is a perspective view of a subassembly of the battery pack of FIGS. 1-4, the subassembly including the battery cell assembly of FIG. 7 and the circuit board of FIG. 6, the battery cell assembly being illustrated with the battery cell holders broken away;

FIG. 10A is a perspective view of the subassembly of FIG. 9 and a potting shell prior to connecting to each other;

FIG. 10B is a perspective view of the subassembly and potting shell of FIG. 10B after having connected them to each other;

FIG. 11A is a section of the subassembly and potting shell of FIG. 10B, the section taken along a plane perpendicular to the circuit board and parallel to the longitudinal axis of battery cells of the battery cell assembly, prior to filling potting resin into the potting shell;

FIG. 11B is a section corresponding to the view of FIG. 11A after having filled potting resin in the potting shell;

FIG. 12 is a perspective view of the subassembly and potting shell of FIG. 10B seen obliquely from below, after having filled potting resin in the potting shell;

FIG. 13 is a perspective view of a main housing cover of the battery pack of FIGS. 1-4;

FIG. 14 is a perspective view of a final assembly step of the battery pack of FIGS. 1-4, wherein the subassembly and potting shell of FIG. 12 is inserted in a battery pack housing including the main housing cover of FIG. 13;

FIG. 15 is a section of the battery pack of FIGS. 1-4, the section taken along the plane XV-XV of FIG. 3, and illustrates the battery pack with the potting broken away; and

FIG. 16 is a flow chart illustrating a method of manufacturing the battery pack of FIGS. 1-4.

All the figures are schematic, not necessarily to scale, and generally only show parts which are necessary in order to elucidate the embodiments, wherein other parts may be omitted.

### DETAILED DESCRIPTION OF THE EXEMPLARY EMBODIMENTS

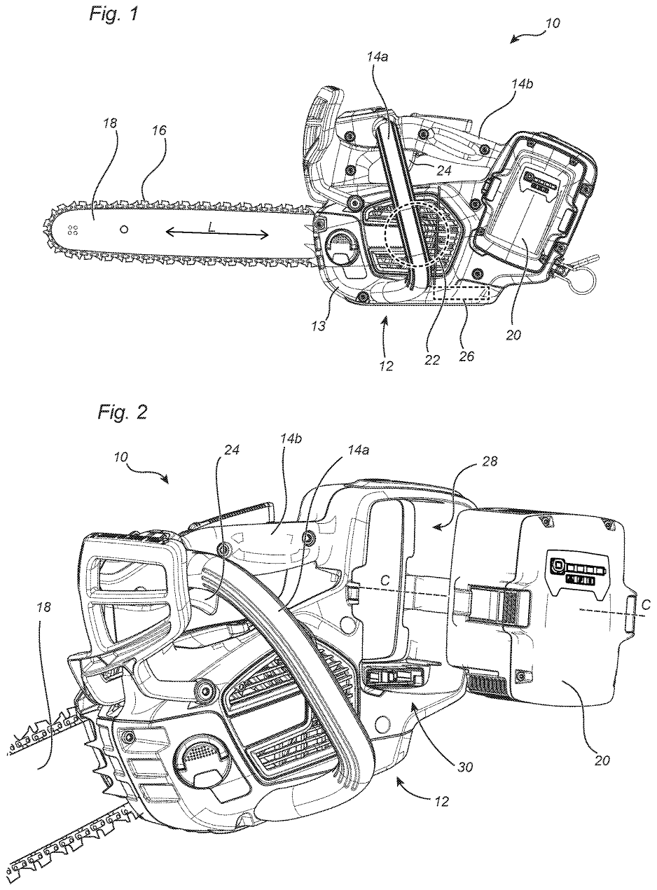

FIG. 1 illustrates a handheld battery-operated power tool embodied as an electric chainsaw 10. The power tool 10 comprises a power unit body 12 provided with a pair of handles 14a, 14b, by means of which an operator (not illustrated) may hold and operate the power tool 10. The pair of handles comprises a front handle 14a, typically for holding with the left hand, and a rear handle 14b, typically for holding with the right hand. The rear handle 14b is positioned on the top of the power unit body 12, i.e. the exemplary chainsaw 10 is of so-called top-handle type; it will however be appreciated that the teachings herein are equally applicable to rear-handle type chainsaws, as well as to other types of handheld battery-operated power tools. The power unit body 12 holds and operates a work assembly, which for the illustrated case is configured as a cutting assembly comprising a saw chain 16, and an elongate guide bar 18 guiding the saw chain 16 in an elongate loop. The cutting assembly extends in a longitudinal direction L from a front end of the power unit body 12. The power tool 10 further comprises a removable, rechargeable battery pack 20, an electric motor 22 (only schematically indicated by a broken-line circle in FIG. 1), and a finger-operated trigger 24 permitting the operator to control the flow of electric power from the battery pack 20 to the electric motor 22. Thereby, the operator can selectively mobilize the saw chain 16 using the electric motor 22. The power tool 10 further comprises a controller 26 (only schematically indicated by a broken-line rectangle in FIG. 1) configured to control the electric motor 22 based on input from the trigger 24. The trigger 24 extends downwards from a bottom face of the rear handle 14b, and is movable between a released position (illustrated), in which the which the saw chain 16 is immobilized, and a fully depressed position (not illustrated), responsive to which the electric motor 22 is operated to move the saw chain 16.

Now with reference to FIG. 2, the power unit body 12 comprises a battery compartment 28 shaped to receive and enclose the battery pack 20. The battery compartment 28 is provided with a battery connector 30 configured to be releasably coupled to a mating power tool connector (not visible in FIG. 2) of the battery pack 20, for transfer of electric power to the electric motor 22 (FIG. 1). The battery pack 20 is insertable into battery compartment 28 of the power unit body 12 along an insertion direction C, which in the illustrated example extends perpendicular to the main extension plane of the guide bar 18 (FIG. 1). The insertion direction C also defines a connection direction of connecting the power tool connector of the battery pack 20 to the battery connector 30 of the power tool 10.

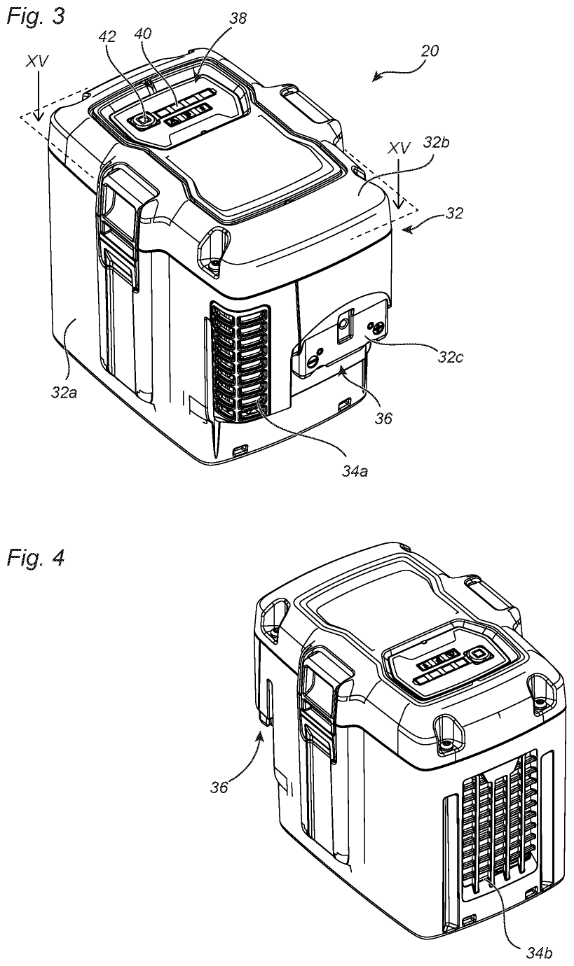

FIG. 3 illustrates the battery pack 20 in greater detail. The battery pack 20 comprises an outer battery pack housing 32 provided with a first ventilation opening 34a for air-cooling of components within the battery pack housing 32. The battery pack 20 further comprises a power tool connector 36 for electrically connecting the battery pack 20 to the battery connector 20 (FIG. 2) of the power tool 10. The battery pack housing 32 may comprise several separate housing parts; in the illustrated example, the battery pack housing 32 comprises a main housing 32a, a main housing main housing cover 32b, and a power tool connector cover 32c. The battery pack 20 further comprises a user interface 38 with indicator lights 40 and a pushbutton 42.

FIG. 4 illustrates the battery pack 20 from another angle, revealing a second ventilation opening 34b opposite to the first ventilation opening 34a (FIG. 3). This enables a continuous air flow through the battery pack 20 from the first ventilation opening 34a to the second ventilation opening 34b or vice versa. The airflow may be generated by a fan in the power unit body 12 (FIG. 1) or within the battery pack 20 itself.

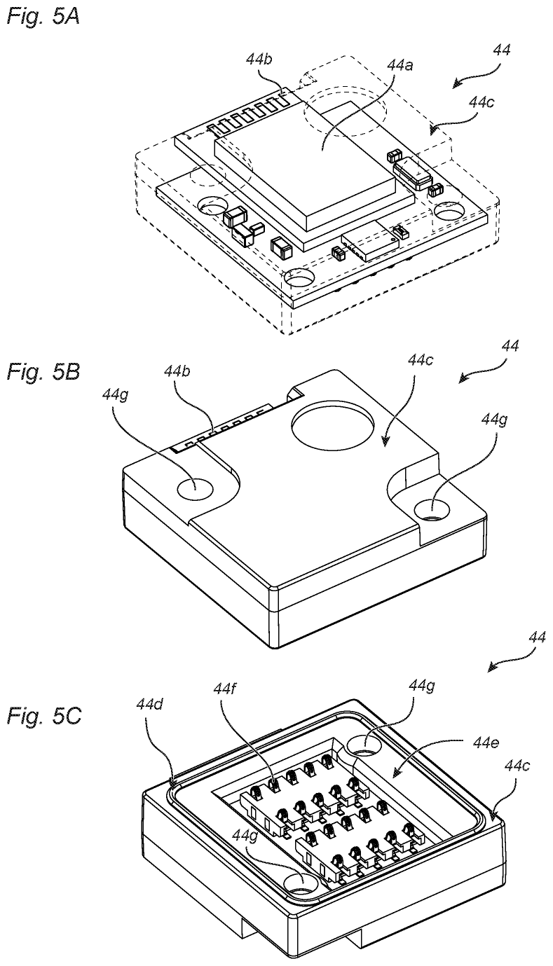

The battery pack 20 incorporates several technical solutions synergistically interoperating to result in a battery pack 20 which is resistant to water and simple to manufacture and maintain. FIGS. 5A-C illustrate a short-range wireless transceiver module, embodied as a Bluetooth Low Energy transceiver, which has been specifically adapted for the battery pack in a manner which will be elucidated further below.

Starting with FIG. 5A, the wireless transceiver module 44 comprises communication circuitry 44a communicating via a radio antenna 44b, which is etched on a printed circuit board. Turning to FIG. 5B, the communication circuitry 44a is separately overmoulded with a plastic overmould body 44c, which is indicated in broken lines in FIG. 5A. The plastic overmould 44c is formed of polyamide having a Shore D hardness of about 40. An exemplary suitable material for the plastic overmould 44c is TECHNOMELT PA 2035 BLACK available from Henkel. As seen from above, the plastic overmould body 44c completely encapsulates the communication circuitry 44a, while allowing the radio antenna 44b to protrude therefrom.

FIG. 5C illustrates the bottom face of the wireless transceiver module 44. The plastic overmould body 44c comprises a sealing ridge 44d, which extends in a closed loop on the bottom face of the wireless transceiver module 44. The sealing ridge 44d extends in a sealing ridge plane and encloses an electrical connector area 44e where the wireless transceiver module 44 comprises a set of electrical connectors 44f for connecting to a circuit board (not illustrated). The electrical connectors 44f are of spring type, to resiliently and releasably abut against connector pads of the circuit board, which connector pads are positioned approximately in the sealing ridge plane. Screw holes 44g penetrate the wireless transceiver module 44.

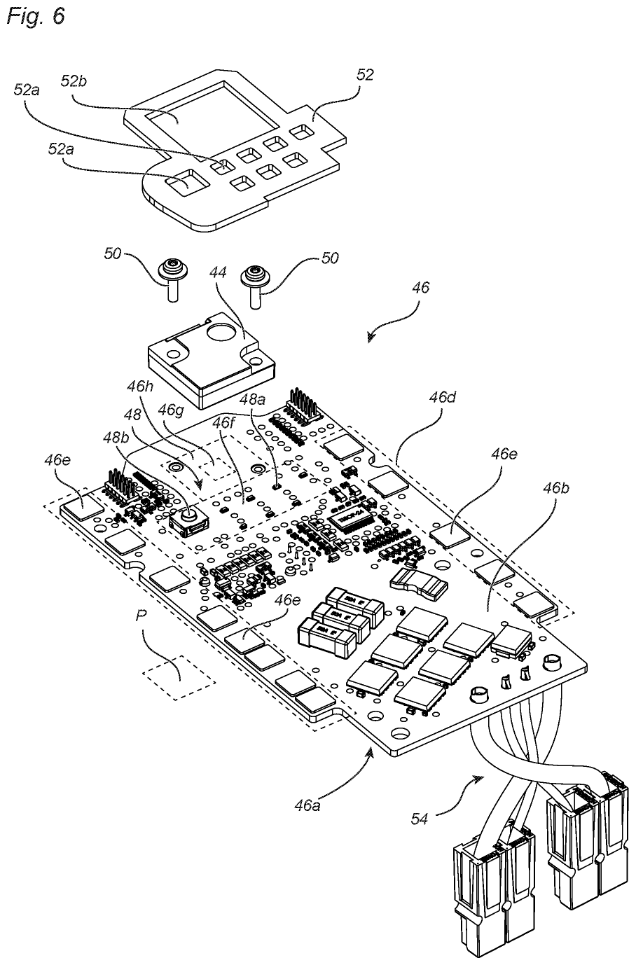

FIG. 6 illustrates a circuit board 46 comprising control electronics configured to operate a battery management system, BMS. The BMS is configured to control the transfer of current between battery cells (not illustrated) within the battery pack 20 (FIG. 1) and the power tool 10 (FIG. 1), and between the battery pack 20 and a battery pack charger (not illustrated). The circuit board 46, which extends in a circuit board plane P, is housed within the outer battery pack housing 32 (FIG. 3) together with the battery cells and has an inner face 46a facing the battery cells and outer face 46b facing away from the battery cells. The circuit board 46 comprises a first terminal connection area 46c and a second terminal connection area 46d, each of which comprises a set of connection pads 46e configured to be electrically connected to battery terminals of the battery cells. The outer face 46b of the circuit board 46 comprises a user interface area 46f comprising a plurality of user interface elements 48, here embodied as a set of light emitting diodes 48a and a microswitch 48b.

The wireless transceiver module 44 is screwed to the circuit board 46 using screws 50 such that the screws 50 bias the wireless transceiver module 44 against the circuit board 46. Thereby, the sealing ridge 44d (FIG. 5C) of the wireless transceiver module 44 is compressed by the bias, and sealingly abuts the circuit board 46. Moreover, the electrical connectors 44f of the wireless transceiver module 44 are biased against the circuit board 46 such that they electrically connect to connection pads (not illustrated) in a wireless transceiver module connection area 46g within a transceiver mounting area 46h of the circuit board 46.

A potting gasket 52 of foam rubber is positioned onto the circuit board 46 such that it encloses the user interface area 46f and the wireless transceiver module connection area 46g. The potting gasket 52 also comprises a plurality of gasket apertures 52a which individually receive respective ones of the user interface elements 48, and a gasket aperture 52b which receives the wireless transceiver module 44.

A set of connector leads 54, configured as insulated cables, extend between the circuit board 46 and the power tool connector 36 (FIG. 3). Respective ones of the connector leads 54 are configured to transfer electric power from the battery cells to the power tool 10, and to communicate with the power tool 10. The connector leads extend from the inner face 46a of the circuit board 46.

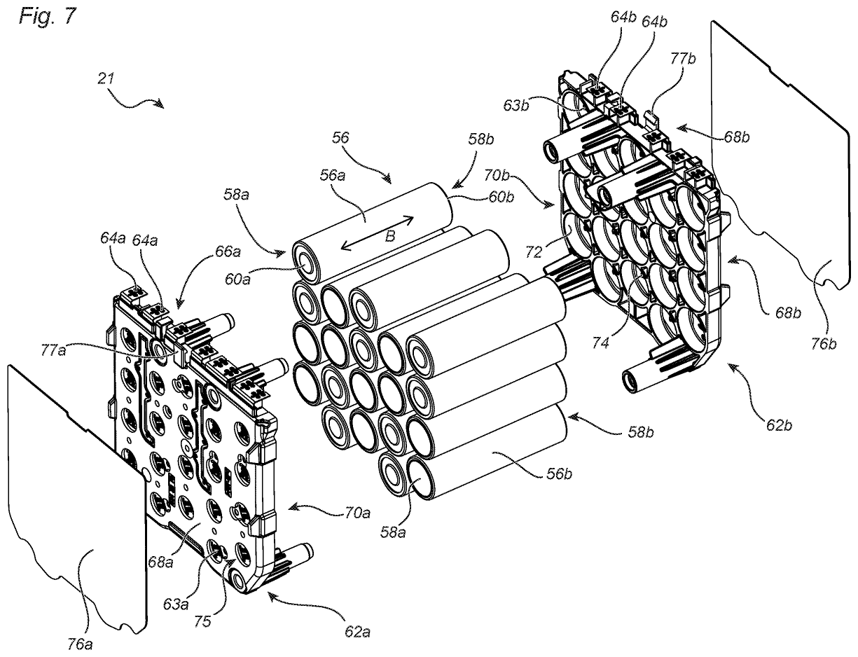

FIG. 7 is an exploded view of a battery cell assembly 21 of the battery pack 20 (FIG. 3). The battery cell assembly comprises a plurality of elongate, rechargeable battery cells 56 of Lithium-ion type. Each battery cell 56 extends in a longitudinal direction B between a respective first battery cell end 58a and a second battery cell end 58b. The battery cell ends 58a, 58b comprise battery cell terminals 60a, 60b of opposite polarity. Some of the battery cells 56, exemplified by battery cell 56a, have a positive battery cell terminal at its respective first battery cell end 60a and a negative battery cell terminal at its respective second battery cell end 60b, whereas other battery cells 56, exemplified by battery cell 56b, have a negative battery cell terminal at its respective first battery cell end 58a and a positive battery cell terminal at its respective second battery cell end 60b.

A first battery cell holder 62a receives the first ends 58a of the plurality of battery cells 56, and a second battery cell holder 62b receives the second ends 58b of the plurality of battery cells 56, to hold the battery cells in a fixed relationship to each other. The first battery cell holder 62a comprises a first set of cell holder terminals 63a which are electrically connected to the battery cell terminals 60a of the first set of battery cell ends 58a, and to a first set of circuit board terminals 64a arranged in a row along a circuit board connector terminal edge 66a of the first battery cell holder 62a. Similarly, the second battery cell holder 62b comprises a second set of cell holder terminals 63b which are electrically connected to the battery cell terminals 60b of the second set of battery cell ends 58b, and to a second set of circuit board terminals 64b arranged in a row along a circuit board connector terminal edge 66b of the second battery cell holder 62b.

The first battery cell holder 62a, which is a plastic element moulded of e.g. polybutylene terephthalate, has a respective outer face 68a facing away from the battery cells 56, and a respective inner face 70a receiving the first set of battery cell ends 58a. For the purpose, the inner face 70a defines a plurality of circular slots 72 (as visible on the second battery cell holder 62b, mutatis mutandis) shaped to matingly receive the first set of battery cell ends 58a. the from the inner face 70a. The first set of cell holder terminals 63a is partly moulded into the first battery cell holder 62a, but the terminals 63a are exposed on the inner face 70a of the battery cell holder 62a via a set of battery cell terminal connection gaps 74 (as visible on the second battery cell holder 62b, mutatis mutandis) enabling the first set of cell holder terminals 63a to electrically connect to the first set of battery cell terminals 60a. The first set of cell holder terminals 63a are also exposed on the outer face 68a of the cell holder 62a via a set of welding gaps 75, which enable welding the first set of cell holder terminals 63a to the first set of battery cell terminals 60a from the outside. Similarly, the second battery cell holder 62b has a respective outer face 68b facing away from the battery cells 56 and a respective inner face 70b receiving the second set of battery cell ends 58b, and the inner face 70b defines a plurality of circular slots 72 matingly receiving the second set of battery cell ends 58b. The second set of cell holder terminals 63a is partly moulded into the plastic of the second battery cell holder 62b, but are exposed on the inner face 70a of the battery cell holder 62a via a set of battery cell terminal connection gaps 74 enabling the second set of cell holder terminals 63b to electrically connect to the second set of battery cell terminals 60b. Also the second set of cell holder terminals 63b is exposed on the outer face 68b of the battery cell holder 62b via a set of welding gaps, which are similar to the welding gaps 75 of the first battery cell holder 62a. The slots 72 may be shaped to sealingly receive the battery cell ends 58a, 58b to prevent penetration of dirt and moisture to the battery cell terminals 60a, 60b from the inner faces of the battery cell holders 62a, 62b. The circuit board connector terminal edges 66a, 66b of the battery cell holders 62a, 62b are provided with cantilever hooks 77a, 77b.

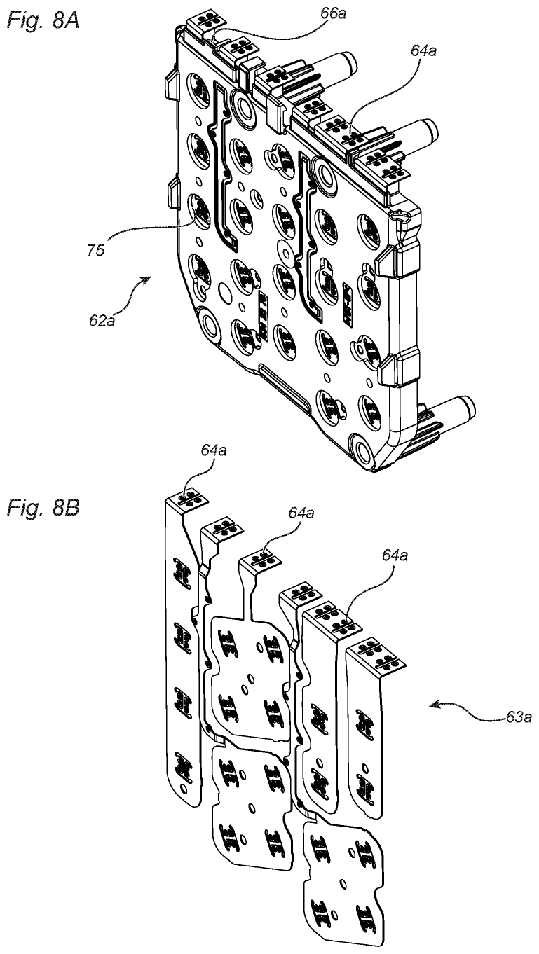

FIG. 8A illustrates the first battery cell holder 62a in greater magnification, and FIG. 8B illustrates the first set of cell holder terminals 63a which is moulded into the battery cell holder 62a.

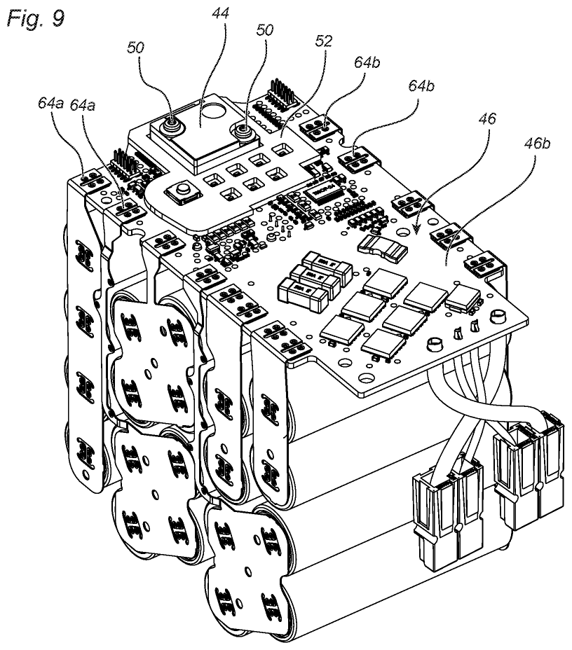

FIG. 9 depicts a subassembly of the battery pack 20 (FIG. 3) with the battery cell holders 62a, 62b (FIG. 7) broken away to illustrate the first and second sets of cell holder terminals 63a, 63b welded to the battery cell terminals 60a, 60b (FIG. 7), thereby connecting subsets of the plurality of battery cells 56 in parallel as well as in series. The first set of circuit board terminals 64a are welded to respective connection pads 46e (FIG. 6) of the first terminal connection area 46d of the circuit board 46, and the second set of circuit board terminals 64b are welded to respective connection pads 46e (FIG. 6) of the second terminal connection area 46e of the circuit board 46. FIG. 9 also illustrates the circuit board 46 with the wireless transceiver module 44 attached, and with the potting gasket 52 positioned on the circuit board 46. The potting gasket 52 is configured as a flexible sheet of closed-cell polyurethane foam rubber provided with an adhesive film for sticking directly onto the outer face 46b of the circuit board 46.

Referring back to FIG. 7, after welding the sets of cell holder terminals 63a, 63b to the battery cell terminals 60a, 60b, the outer faces 68a, 68b of the cell holders 62a, 62b are covered by respective cell holder cover sheets 76a, 76b. The cell holder cover sheets 76a, 76b are configured as flexible sheets of closed-cell polyurethane foam rubber provided with an adhesive film for sticking directly onto the outer faces 68a, 68b of the respective cell holders 62a, 62b.

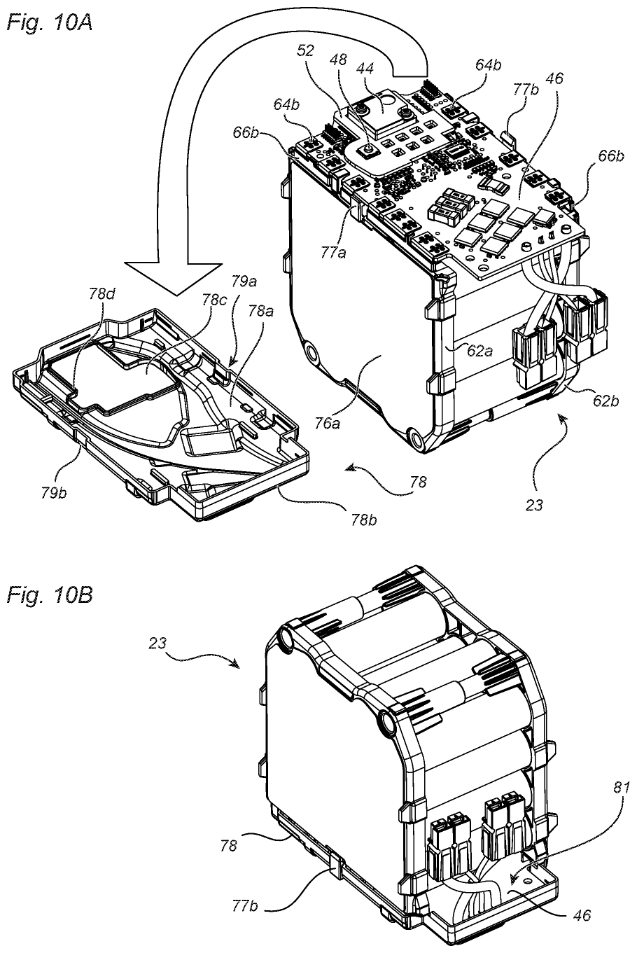

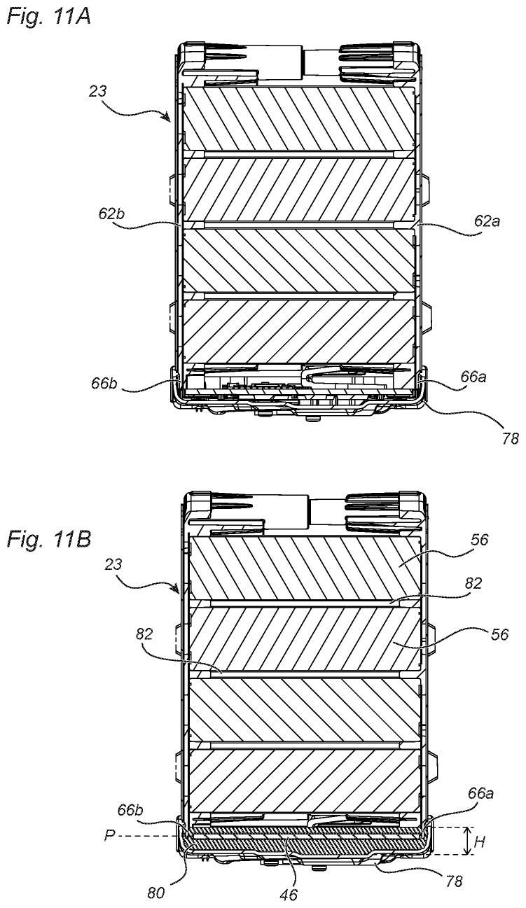

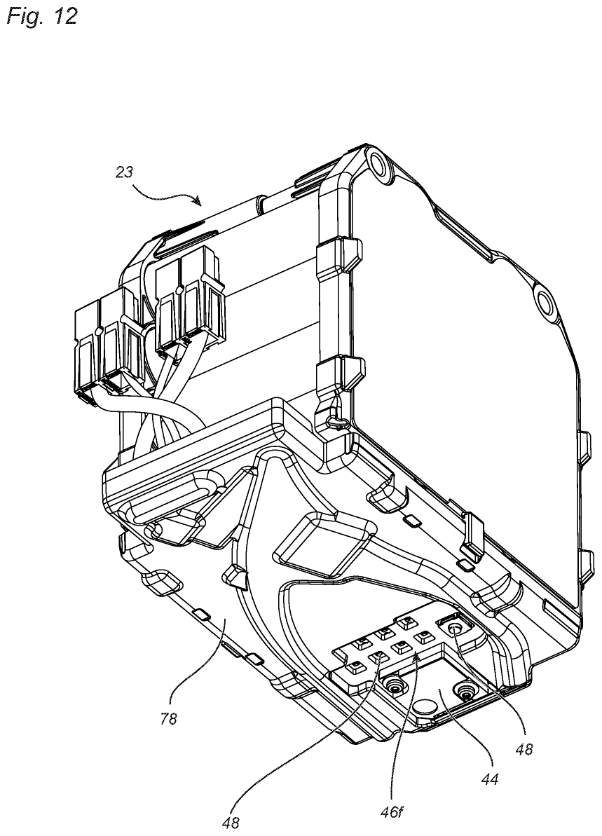

FIG. 10A illustrates a subassembly 23 of the battery pack 20 (FIG. 3) comprising the battery cell assembly 21 of FIG. 7 connected to the circuit board 46, and in a state ready for potting. FIG. 10A also illustrates a potting shell 78 shaped as a tray. The potting shell 78 has an inner face 78a which will face the circuit board 46 when potting, and an outer face 78b facing away from the circuit board. The potting shell 78 further comprises a potting shell opening 78c enclosed by a gasket compression ridge 78d on the inner face 78a. Prior to potting, the subassembly 23 is turned and placed with the circuit board down in the potting shell 78, with the potting shell opening 78c in register with the user interface area 46f (FIG. 6) and the transceiver mounting area 46h (FIG. 6). Thereafter, the circuit board 46 is pressed against the potting shell 78 such that the gasket compression ridge 78d compresses the potting gasket along a sealing line extending in a closed loop about the user interface area 46f (FIG. 6) and the wireless transceiver module 44 (FIG. 6). When the potting gasket 52 is in a compressed state, the cantilever hooks 77a, 77b interlock with mating structures 79a, 79b on the outer face 78b of the potting shell 78, thereby fixing the position of the circuit board 46 in relation to the potting shell 78. Finally, when in the position of FIG. 10B, potting resin is injected into the potting shell 78 from above, for example at the position indicated by arrow 81, and allowed to cure. The gasket compression ridge 78d (FIG. 10A) prevents leakage of potting resin through the potting shell opening 78c, and keeps the user interface area 46f and transceiver mounting area 46h (FIG. 6) free from potting resin. An exemplary suitable potting resin for the application a polyurethane-based potting resin, such as WEVOPUR 552 FL available from WEVO-CHEMIE GmbH.

The sections of FIGS. 11A and 11B schematically illustrate the subassembly 23 with the potting shell 78 prior to potting (FIG. 11A) and after potting (FIG. 11B). In FIG. 11B, the circuit board 46 and the first and second battery cell holders 62a, 62b are partly embedded in a coherent, homogeneous body 80 of potting resin. More precisely, the first and second sets of circuit board terminals 64a, 64b (FIG. 7), the first and second terminal connection areas 46c, 46d (FIG. 6), the circuit board connector terminal edges 66a, 66b (FIG. 7) of the battery cell holders 62a, 62b, the inner face 46a (FIG. 6) of the circuit board 46, parts of the outer face 46b (FIG. 6) of the circuit board 46, and a section of the connector leads 54 (FIG. 6) adjacent to the circuit board 46 are embedded in the body 80 of potting resin. The potting shell 78 is bonded to the body 80 of potting resin, and will remain in the final product, i.e. the battery pack 20 (FIG. 3).

At the same time, and now with reference to FIG. 12, the user interface area 46f with the user interface elements 48 and the wireless transceiver module 44 are free from potting resin. Referring back again to FIG. 11B, also the battery cells 56, as well as the main part of the battery cell holders 62a, 62b, are free from potting resin. In particular, having the battery cells 56 outside the body 80 of potting resin enables the airflow between the first and second ventilation openings 34a, 34b (FIGS. 3 and 4) to pass through air gaps 82 between adjacent battery cells 56. The body 80 of potting resin has a total height H, perpendicular to the circuit board plane P, of about 15 mm.

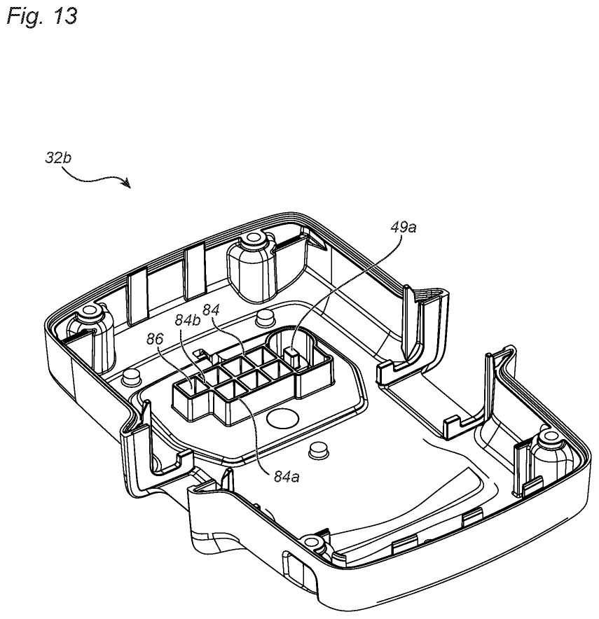

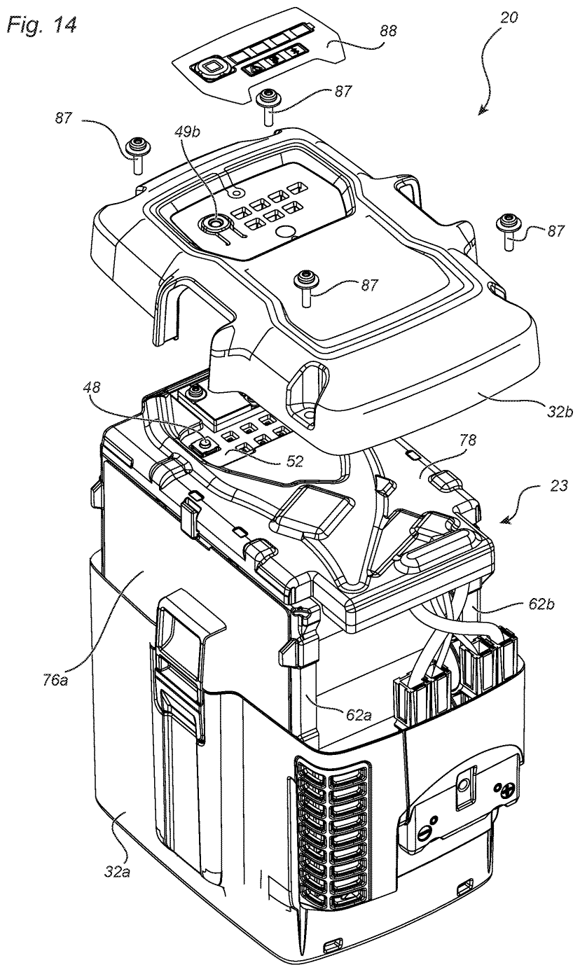

FIG. 13 illustrates the inside face of the main housing cover 32b of the battery pack housing 32 (FIG. 3). The main housing cover 32b comprises a gasket compression ridge 84, which is shaped to be in register with and enclose the user interface area 46f (FIG. 6) of the circuit board 46 when the subassembly 23 of FIG. 12 is positioned within the cover 32 (FIG. 3). An outer perimeter 84a of the gasket compression ridge 84 is shaped to enclose the entire user interface area 46f, but interior sections of the gasket compression ridge 84b also define individual slots 86 for receiving respective ones of the user interface elements 48 (FIG. 6). A switch pusher 49a, positioned to be in register with the microswitch 48b when the battery pack 20 (FIG. 20) is fully assembled, is arranged on the inner face of a cantilever element integrally formed with the main housing cover 32b; the cantilever element 49b is indicated in FIG. 14.

FIG. 14 illustrates the positioning of the subassembly 23 of FIG. 12 into the battery pack housing 32. The subassembly 23 is slid into the main housing 32a, thereby slightly compressing the cell holder cover sheets 76a, 76b (FIG. 7) between the cell holders 62a, 62b and the main housing 32a. Thereafter, the main housing cover 32b is placed on top of the potting shell 78, and screws 87 are tightened to bias the main housing cover 32b against the main housing 32a. Thereby, the gasket compression ridge 84 compresses the potting gasket along a closed-loop sealing line about each of the user interface elements 48, such that a liquid-tight engagement is obtained. Finally, a transparent sticker 88 with printed symbols is applied onto the outer face of the main housing cover 32b, to result in a water and dirt-tight outer layer covering the user interface elements.

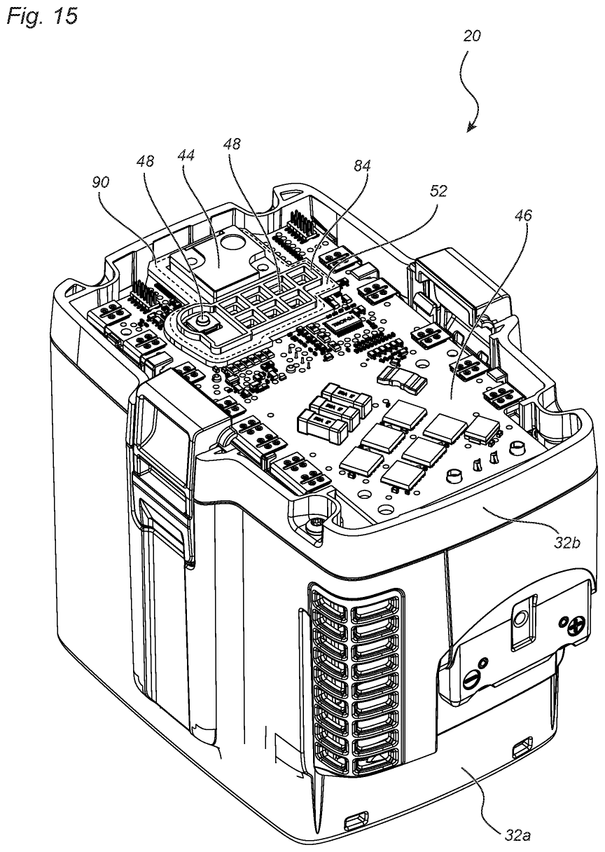

FIG. 15 illustrates a section of the final battery pack 20 along the plane XV-XV indicated in FIG. 3, and with the potting shell 78 and the body of potting resin 80 (FIG. 11B) broken away. The gasket compression ridge 78d (not illustrated) of the potting shell 78 compresses the potting gasket 52 along an outer sealing line 90, whereas the gasket compression ridge 84 of the cover 32 extends through the potting shell opening (FIG. 10A) towards the circuit board and compresses the potting gasket 52 within the perimeter of the outer sealing line 90.

The absence of potting on the wireless transceiver module 44 enables removal of the wireless transceiver module 44 from the potted circuit board 46, for example for replacement. In an alternative manufacturing order, the circuit board 46 may be potted following the potting procedure described above prior to connecting the wireless transceiver module 44; instead, the area of the circuit board 46 reserved for the wireless transceiver module 44 may be kept free from potting within the sealing line 90. Following such a procedure, the wireless transceiver module 44 may be an optional accessory that can be optionally connected to the unpotted area after potting.

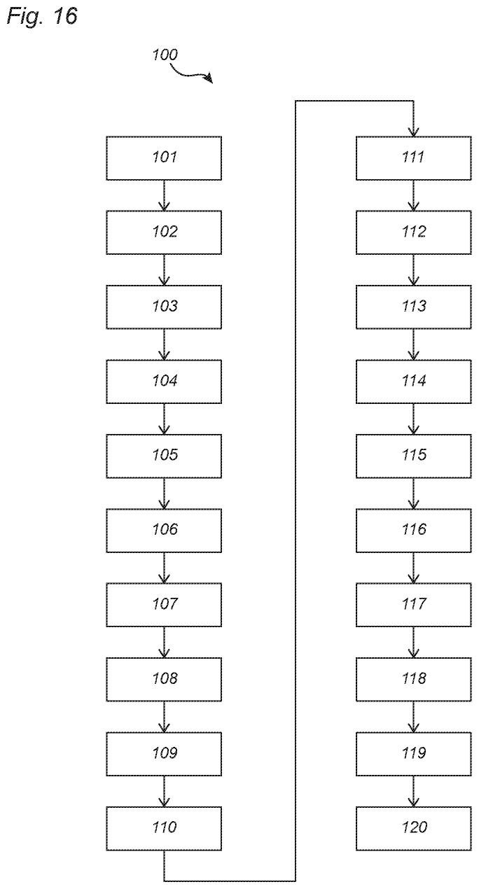

The flow chart of FIG. 16 schematically summarizes a method 100 of manufacturing the rechargeable battery pack 20 described hereinabove. The method, which includes several optional method steps, comprises the steps
101: providing the plurality of battery cells 56 (FIG. 7), the circuit board 46 (FIG. 6), and the first and second battery cell holders 62a, 62b (FIG. 7);
102: positioning the first set of battery cell ends 58a (FIG. 7) in the first battery cell holder 62a;
103: positioning the second set of battery cell ends 58b (FIG. 7) in the second battery cell holder 62b;
104: positioning the circuit board 46 adjacent to the circuit board connector terminal edges 66a, 66b (FIG. 7) of the first and second battery cell holders 62a, 62b, such that the inner face 46a (FIG. 6) of the circuit board 46 faces the battery cells 56 and the outer face 46b (FIG. 6) of the circuit board 46 faces away from the battery cells 56;
105: welding the first set of cell holder terminals 63a (FIG. 8B) of the first battery cell holder 62a to the battery cell terminals 60a (FIG. 7) of the first set of battery cell ends 58a via the set of welding gaps 75 (FIG. 7) through of first cell holder 62a;
106: welding the second set of cell holder terminals 63b (FIG. 7) of the second battery cell holder 62b to the battery cell terminals 60b of the second set of battery cell ends 58b via the set of welding gaps 75 through the second cell holder 62b;
107: applying the first cell holder cover sheet 76a (FIG. 7) on the outer face 68a (FIG. 7) of the first cell holder 62a to cover the set of welding gaps 75 through the first cell holder 62a;
108: applying the second cell holder cover sheet 76b (FIG. 7) on the outer face 68b (FIG. 7) of the second cell holder 62b to cover the set of welding gaps 75 through the second cell holder 62b;
109: electrically connecting the circuit board terminals 64a, 64b of the first and second battery cell holders 62a, 62b to the circuit board 46;
110: positioning the potting gasket 52 (FIG. 6) between the circuit board 46 and the potting shell 78 (FIG. 10) to enclose the user interface area 46f and the transceiver mounting area 46h (FIG. 6) of the circuit board 46;
111: placing the circuit board 46 and the circuit board connector terminal edges 66a, 66b (FIG. 7) of the first and second battery cell holders 62a, 62b in the potting shell 78, with the outer face 46b of the circuit board 46 facing downwards and the first and second battery cell holders 62a, 62b extending up from the potting shell 78, and with the potting shell opening 78c (FIG. 10) in register with the user interface area 46f and the transceiver mounting area 46h;
112: compressing the potting gasket 52 by pressing the circuit board 46 against the potting shell 78, and optionally locking the potting shell in relation to the circuit board with the potting gasket 52 in compressed state, for example by attaching the battery cell holders 62a, 62b to the potting shell 78, such that, when filling the potting resin in the potting shell 78, the potting gasket 52 prevents the potting resin from reaching the user interface area 46f and the transceiver mounting area 46h;
114: filling potting resin in the potting shell 78, to form the coherent body 80 (FIG. 11B) of potting resin at least partly embedding the circuit board connector terminal edges 66a, 66b (FIG. 7) of the first and second battery cell holders 62a, 62b and the circuit board 46;
116: providing the main housing cover 32b of the outer battery pack housing 32;
118: compressing the potting gasket 52 by pressing the main housing cover 32b of the outer battery pack housing 32 against the potting gasket 52 within the perimeter of the potting shell opening 78c (FIG. 10A), such that a sealing engagement is obtained between the cover 32c of the outer battery pack housing 32 and the circuit board 46 via the potting gasket 52; and
120: fixing the outer battery pack housing in relation to the circuit board.

The invention has mainly been described above with reference to a few embodiments. However, as is readily appreciated by a person skilled in the art, other embodiments than the ones disclosed above are equally possible within the scope of the invention, as defined by the appended patent claims.

For example, the invention has been described with reference to a chainsaw battery pack. However, it will be appreciated that the teachings herein are equally applicable to other rechargeable battery packs intended for use in wet and/or dirty areas.

In the claims, the word “comprising” does not exclude other elements or steps, and the indefinite article “a” or “an” does not exclude a plurality.

1. A rechargeable battery pack configured to be removably attached to a handheld battery-operated power tool, the rechargeable battery pack comprising:
a plurality of elongate, rechargeable battery cells, each battery cell extending in a longitudinal direction between a pair of opposing battery cell ends, said pair of battery cell ends comprising battery cell terminals of opposite polarity;
a circuit board comprising control electronics;
a first battery cell holder configured to receive a first set of battery cell ends comprising one end of each of said plurality of battery cells, the first battery cell holder comprising a first set of cell holder terminals connected to the battery cell terminals of said first set of battery cell ends, and a first set of circuit board terminals arranged along a circuit board connector terminal edge of the first battery cell holder, the first set of circuit board terminals being connected to a first terminal connection area of the circuit board; and
a second battery cell holder configured to receive a second set of battery cell ends comprising the other end of each of said plurality of battery cells, the second battery cell holder comprising a respective set of cell holder terminals connected to the battery cell terminals of said second set of battery cell ends, and a second set of circuit board terminals arranged along a circuit board connector terminal edge of the second battery cell holder, the second set of circuit board terminals being connected to a second terminal connection area of the circuit board,
wherein the first battery cell holder is partly embedded in a coherent body of potting resin, wherein first set of circuit board terminals, the first terminal connection area, and the circuit board connector terminal edge of the first battery cell holder are embedded in said coherent body of potting resin.

2. The rechargeable battery pack according to claim 1, wherein the second terminal connection area, the second set of circuit board terminals and the circuit board connector terminal edge of the second battery cell holder are embedded in said coherent body of potting resin.

3. The rechargeable battery pack according to claim 1, wherein at least some of said plurality of battery cells are outside said coherent body of potting resin, or
wherein the rechargeable battery pack comprises air gaps between adjacent battery cells and an outer battery pack housing provided with a ventilation opening in fluid communication with said air gaps.

4. (canceled)

5. (canceled)

6. The rechargeable battery pack according to claim 1, wherein the circuit board comprises an inner face facing said plurality of battery cells and outer face facing away from said plurality of battery cells.

7. The rechargeable battery pack according to claim 6, wherein said inner face of the circuit board is embedded in said coherent body of potting resin.

8. The rechargeable battery pack according to claim 7, wherein the rechargeable battery pack comprises an electric connector for connection to the handheld battery-operated power tool, and a set of connector leads extending between the circuit board and the electric connector, wherein the connector leads extend from the inner face of the circuit board, through the coherent body of potting resin.

9. The rechargeable battery pack according to claim 6, wherein said outer face of the circuit board is at least partly embedded in said coherent body of potting resin.

10. The rechargeable battery pack according to claim 9, wherein the coherent body of potting resin is bonded to a potting shell at least partly enclosing the coherent body of potting resin.

11. The rechargeable battery pack according to claim 10, wherein said outer face of the circuit board comprises a user interface area comprising a plurality of user interface elements free from said coherent body of potting resin, and a potting gasket enclosing said user interface area and abutting said coherent body of potting resin, said potting gasket being compressed by a gasket compression ridge on an inner face of the potting shell.

12. The rechargeable battery pack (20) according to claim 11, wherein the potting shell is provided with a potting shell opening in register with the user interface area, wherein the user interface area is free from said coherent body of potting resin.

13. The rechargeable battery pack according to claim 12, further comprising an outer battery pack housing provided with a gasket compression ridge extending through the potting shell opening towards the circuit board, wherein said potting gasket is compressed by the gasket compression ridge of the outer battery pack housing.

14. The rechargeable battery pack according to claim 13, wherein the potting gasket comprises a plurality of gasket apertures individually enclosing respective user interface elements, and the gasket compression ridge of the outer battery pack housing compresses the potting gasket in closed loops about the respective gasket apertures, and wherein the potting gasket is configured as a coherent foam rubber sheet.

15. (canceled)

16. The rechargeable battery pack according to claim 1, wherein said circuit board extends in a circuit board plane, and wherein said coherent body of potting resin has a total height, perpendicular to the circuit board plane, of less than 40 mm, or
wherein the cell holder terminals of said first set of cell holder terminals are at least partly moulded into the first battery cell holder.

17. (canceled)

18. The rechargeable battery pack according to claim 1, wherein said first battery cell holder has an outer face facing away from the battery cells, and an inner face receiving the first set of battery cell ends, wherein said first battery cell holder is provided with a set of gaps in register with the battery cell terminals of said first set of battery cell ends, the gaps exposing said first set of cell holder terminals on the outer face of said first battery cell holder.

19. The rechargeable battery pack according to claim 18, further comprising a flexible cell holder cover sheet on the outer face of the first battery cell holder, the cell holder cover sheet covering said set of gaps exposing said first set of cell holder terminals on the outer face of said first battery cell holder, wherein the first cell holder cover sheet is a foam rubber sheet.

20. (canceled)

21. A rechargeable battery pack configured to be removably attached to a handheld battery-operated power tool, for example as defined in any of the preceding claims, the rechargeable battery pack comprising:
a plurality of elongate, rechargeable battery cells;
a circuit board comprising control electronics, the circuit board comprising a transceiver mounting area comprising a wireless transceiver module, wherein the circuit board is partly embedded in a coherent body of potting resin, and wherein the transceiver mounting area is free from said coherent body of potting resin; and
a potting gasket abutting said coherent body of potting resin and separating said transceiver mounting area from said coherent body of potting resin,
wherein said wireless transceiver module is separately overmoulded with a plastic overmould body, wherein said plastic overmould body comprises a sealing ridge extending in a closed loop on a bottom face of the wireless transceiver module, the sealing ridge sealingly abutting the circuit board.

22. The rechargeable battery pack according to claim 21, wherein the bottom face of the wireless transceiver module comprises a set of connection terminals connected, but unsoldered, to a mating set of connection terminals of the circuit board, wherein the wireless transceiver module is biased to the circuit board.

23-25. (canceled)

26. A method of manufacturing a rechargeable battery pack, comprising:
providing a plurality of battery cells, a circuit board, a first battery cell holder comprising a respective set of circuit board terminals arranged along a circuit board connector terminal edge of the first battery cell holder, and a second battery cell holder comprising a respective set of circuit board terminals arranged along a circuit board connector terminal edge of the second battery cell holder;
positioning a first set of battery cell ends of the plurality of battery cells in the first battery cell holder;
positioning a second set of battery cell ends of the plurality of battery cells in the second battery cell holder;
positioning the circuit board adjacent to the circuit board connector terminal edges of the first and second battery cell holders, such that an inner face of the circuit board faces said plurality of battery cells and outer face of the circuit board faces away from said plurality of battery cells;
electrically connecting the circuit board terminals of the first and second battery cell holders to the circuit board;
placing the circuit board and the circuit board connector terminal edges of the first and second battery cell holders in a potting shell shaped as a tray, with the outer face of the circuit board facing downwards into the potting shell and the first and second battery cell holders extending up from the potting shell; and
filling potting resin in the potting shell, to form a coherent body of potting resin at least partly embedding the circuit board connector terminal edges the first and second battery cell holders and the circuit board.

27. The method according to claim 26, comprising, prior to filling potting resin in the potting shell,
positioning a potting gasket between the circuit board and the potting shell, the potting gasket enclosing a user interface area and/or a transceiver mounting area of the circuit board; and
compressing the potting gasket by pressing the circuit board against the potting shell such that, when filling the potting resin in the potting shell, the potting gasket prevents the potting resin from reaching said user interface area and/or transceiver mounting area,
wherein the potting shell is provided with a potting shell opening in register with said user interface area and/or transceiver mounting area, the method further comprising
providing an outer battery pack housing, and
compressing the potting gasket by pressing the outer battery pack housing against the potting gasket within the perimeter of the potting shell opening, such that a sealing engagement is obtained between the outer battery pack housing and the circuit board via the potting gasket, and
fixing the outer battery pack housing in relation to the circuit board.

28. (canceled)

29. The method according to claim 26, further comprising:
welding a set of cell holder terminals of the first battery cell holder to battery cell terminals of the first set of battery cell ends via a set of gaps through said first battery cell holder;
welding a set of cell holder terminals of the second battery cell holder to battery cell terminals of the second set of battery cell ends via a set of gaps through said second battery cell holder;
applying a first flexible cell holder cover sheet on an outer face of the first battery cell holder to cover the set of gaps through the first cell holder; and
applying a second flexible cell holder cover sheet on an outer face of the second battery cell holder to cover the set of gaps through the second battery cell holder.
